(19) United States
(12) Patent Application Publication
(10) Pub. No.: US 2010/0044442 A1
(43) Pub. Date: Feb. 25, 2010

(54) PROXIMITY IDENTIFICATION CARD WITH OPTIMALLY SIZED ANTENNA AND SHIELDED LABEL

(76) Inventor: Simon Phillips, York (GB)

Correspondence Address: BUCKLEY, MASCHOFF & TALWALKAR LLC, 50 LOCUST AVENUE, NEW CANAAN, CT, 06840, US

(21) Appl. No.: 11/964,938

(22) Filed: Dec. 27, 2007

(51) Int. Cl. G06K 19/02; G06K 19/067

(52) U.S. Cl. 235/488; 235/492; 235/487

(57) ABSTRACT

A mailable assembly includes a backing sheet and a proximity identification card adhered by its rear surface to the backing sheet. The card includes a plastic body, a radio frequency identification (RFID) chip embedded in the plastic body, and an antenna embedded in the plastic body and coupled to the RFID chip. The assembly also includes a protective label adhered to the front surface of the card. The label includes an adhesive layer by which the label is adhered to the card and at least one conductive layer for shielding the antenna from RF radiation.

### BACKGROUND

Payment cards such as credit or debit cards are ubiquitous. For decades, such cards have included magnetic stripe cards on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

In pursuit of still greater convenience and more rapid transactions at POS terminals, payment cards have more recently been developed that allow the account number to be automatically read from the card by radio frequency communication between the card and a so-called “proximity reader” that may be incorporated with the POS terminal. In such cards, often referred to as “proximity payment cards”, a radio frequency identification (RFID) integrated circuit (IC, often referred to as a “chip”) is embedded in the card body. A suitable loop antenna, formed of one or more turns of a conductive material, is also embedded in the card body. There are conductive connections between the antenna and the RFID chip to allow the chip to receive and transmit data by RF communication via the antenna. In typical arrangements, the RFID chip is powered from an interrogation signal that is transmitted by the proximity reader and received by the card antenna.

MasterCard International Incorporated, the assignee hereof, has established a widely-used standard, known as “PayPass”, for interoperability of proximity payment cards and proximity readers.

Conventional practices call for the loop antenna in a proximity payment card to generally follow the outline of the card body in order to maximize the planar extent of the antenna. All other things being equal, the larger the extent of the antenna, the more reliable is the coupling between the proximity payment card and the proximity reader.

The present inventor has recognized a need to provide enhanced security for proximity payment devices. One issue the inventor has addressed is the potential for proximity payment cards to be read by unauthorized persons who have the intention of collecting account number for fraudulent purposes.

### BRIEF DESCRIPTION OF THE DRAWINGS

FIG. 1 is a schematic plan view of a mailable assembly which includes a proximity payment card and which is provided in accordance with aspects of the present invention.

FIG. 2 is a schematic side view of the mailable assembly of FIG. 1.

FIG. 3 is a schematic plan view of the proximity payment card shown in FIGS. 1 and 2.

FIG. 4 is a schematic sectional view of a shielding label which is part of the mailable assembly of FIGS. 1 and 2.

FIG. 5 is a view similar to FIG. 2, showing an alternative embodiment of the mailable assembly.

FIG. 6 is a flow chart that illustrates aspects of a method provided in accordance with some embodiments.

### DETAILED DESCRIPTION

In general, and for the purpose of introducing concepts of embodiments of the present invention, an assembly in which a proximity payment card is mailed to the intended holder thereof also includes a protective label that is adhered to the face of the card and shields the card antenna to prevent unauthorized reading of the card while it is in transit. According to other aspects, the size of the card antenna is reduced, and the antenna is located within the card body, so that the protective label may be the same size and in the same location on the card as labels that are applied to payment cards in conventional card fulfillment operations.

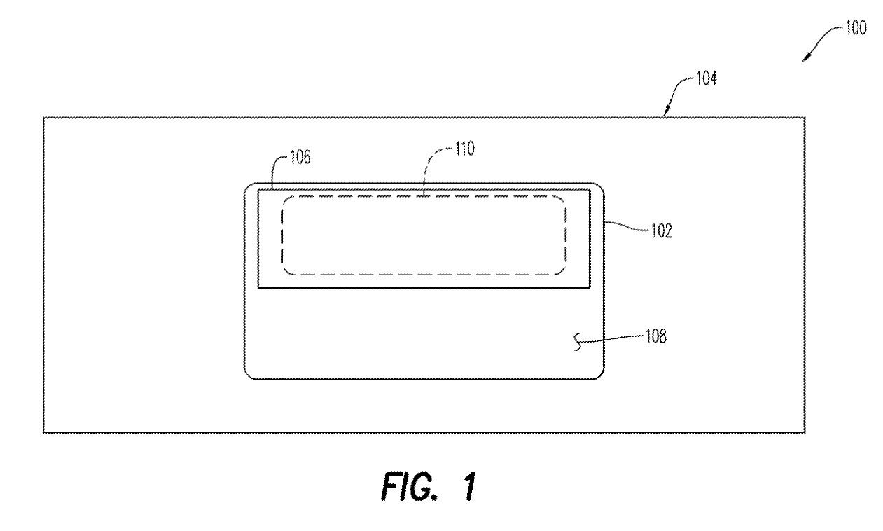

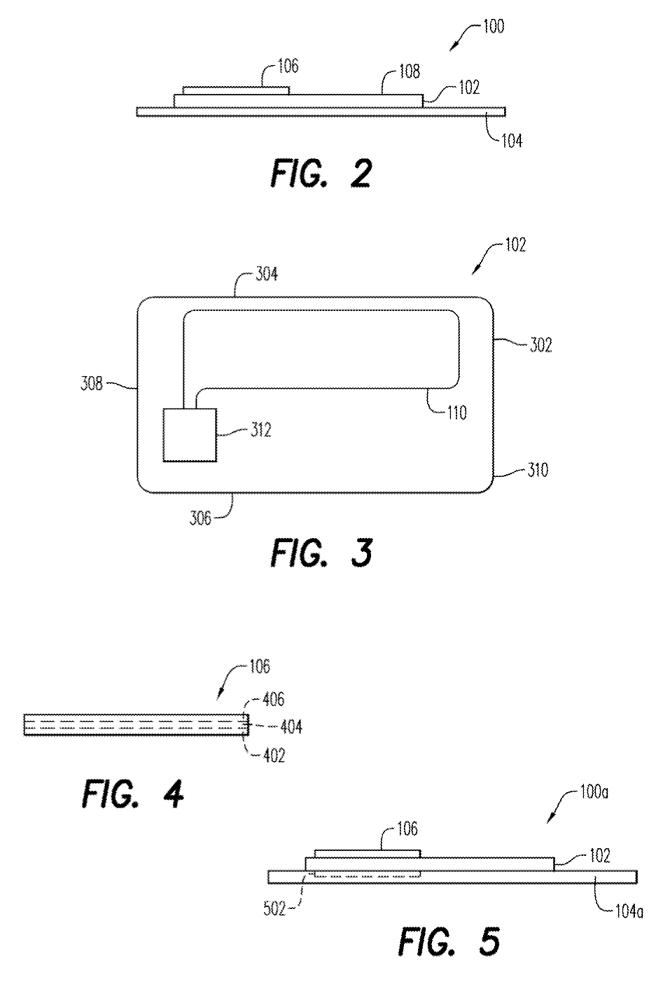

FIG. 1 is a schematic plan view of a mailable assembly 100 which includes a proximity payment card 102 and which is provided in accordance with aspects of the present invention. FIG. 2 is a schematic side view of the mailable assembly 100.

The mailable assembly 100 includes a backing sheet 104 to which the proximity payment card 102 is adhered. The mailable assembly 100 also includes a protective label 106 which is adhered to the face (front surface 108) of the proximity payment card 102.

The rounded-corner dashed line rectangle indicated at 110 in FIG. 1 substantially indicates the locus of a loop antenna which is embedded in the proximity payment card 102. The antenna 110 is also schematically shown in a somewhat different fashion in FIG. 3.

FIG. 3 is a schematic plan view of the proximity payment card 102. The proximity payment card 102 includes a plastic card body indicated by reference numeral 302 in FIG. 3. The card body 102 is generally rectangular and planar and has dimensions in accordance with the well known ID-1 standard for identification cards. Consequently, the length of the card body 302 and of the card 102 is substantially 85.6 mm and the width or height of the card body 302 and of the card 102 is substantially 53.98 mm. With these dimensions, issuance of the card may be processed using conventional identification card processing equipment. It will be observed that the card body 302 has two relatively long edges 304 and 306 and two relatively short edges 308 and 310. The long edges 304 and 306 are parallel to each other and the short edges 308 and 310 are parallel to each other.

The proximity payment card 102 also includes an RFID chip 312. The antenna 110 is coupled to the RFID chip 312 in a conventional manner to allow for the RFID chip 312 to receive power signals from, and to exchange RF communications with, proximity reader components (not shown) of POS terminals (not shown). The RFID chip 312 is embedded in the card body 302. An account number that corresponds to the account to be accessed with the proximity payment card 102 is stored in the RFID chip 312 in such a manner that the account number is transmitted from the proximity payment card 102 to a proximity reader component of a POS terminal during a conventional interaction between the proximity payment card 102 and the proximity reader.

In accordance with conventional practices, the antenna 110 may be formed of one or more loops of a conductive material, located substantially as indicated in FIGS. 1 and 3.

For reasons that will be made clear below, it is preferable that the antenna 110 have a certain geometry, certain dimensions, and be located in a certain manner within the card body 302. The preferred antenna geometry, dimensions and location as described below are premised on the card body having the above-mentioned ID-1 standard dimensions.

It is preferred then that the antenna 110 be substantially rectangular with a length of substantially 70 mm and a width of 22 mm. It is preferred that the antenna 110 be located 3.5 mm from the top edge 304 of the card body 302 and located 7.8 mm from the side edges 308 and 310 of the card body 302. With this geometry, set of dimensions and location within the card body 302, the antenna 110 may achieve a preferred accommodation between two competing objectives. The first objective is the conventional objective of having the antenna as large in extent as is practically possible. The second objective, which is not believed to have been recognized in the prior art, is to accommodate the antenna to being shielded by a label to be applied to the proximity payment card 102 before the proximity payment card 102 is mailed to the prospective card holder. In particular, the second objective calls for the label to be provided in accordance with a standard size for such labels, and for the label to be applied to the proximity payment card on a customary location on the proximity payment card. By achieving the second objective, the present invention may allow conventional processing equipment and card processing procedures to be employed while providing enhanced security for proximity payment cards while the same are in transit from the card issuer to the prospective card holder. In other words, the proposed preferred antenna geometry, dimensions and location may essentially eliminate any disruption to card issuance procedure from a proposed new security feature, since card issuers would not be required to purchase new card processing equipment, nor to modify currently owned card processing equipment, nor to modify card processing procedures. The only changes required of card issuers, if the preferred proximity card embodiment is employed, are that they obtain a supply of card blanks with the antenna geometry, dimensions and location as described above in connection with FIG. 3 and that they use a label stock with an antenna shielding capability as described below. Thus the additional card security feature proposed herein may be implemented by card issuers with little additional cost.

There will now be provided a further explanation for the preferred antenna geometry, dimensions and location. It is customary in issuing a payment card to apply a label to the payment card. The label may, for example, instruct the card holder to call a certain toll-free telephone number for the purpose of confirming receipt of, and activating, the payment card. The label often complies with a standard size, which is rectangular, 76.2 mm by 25. 4 mm. The location at which the label is customarily applied to the payment card (an ID-1 card) is typically 2.54 mm from the top card edge, with a tolerance of plus or minus 0.51 mm, and 2.54 mm from either the left card edge or the right card edge, again with a tolerance of plus or minus 0.51 mm. Given this standard size of the label, and its standard location (with the above noted tolerances) on the payment card, the above-recited preferred geometry, dimensions and location of the antenna as described above in connection with FIG. 3 result in the largest possible extent of the antenna consistent with having the antenna substantially completely covered by the label. (Smaller antennas may alternatively be employed, but are not preferred.) Although not shown in the drawings, the proximity payment card may have additional features, such as a magnetic stripe that allows it to be read by POS terminal mag stripe readers. Another possible additional feature may be a paper tape on the back of the card on which the card holder may write his/her signature. Also there may be printed and/or embossed information on the card (such as payment card account number, card holder's name, etc.) and branding information such as the name and/or logo of the issuing bank and of the payment card association (e.g., MasterCard) of which the issuing bank is a member.

FIG. 4 is a schematic sectional view of the protective label 106. As shown, the label includes three layers, although there may be more or fewer than three. The lower layer 402 may be an adhesive by which the label may be adhered to the proximity payment card 102. The layer 402 may be of conventional composition. The middle layer 404 may be a conductive material such as a metal foil, suitable for shielding the antenna 110 from receiving RF radiation. The upper layer 406 may, for example, be paper or another material suitable for printing instructions to the card holder about how to activate the card.

Given the shielding layer 404 of the label 106, it will be appreciated from FIG. 1, and the position of label 106 relative to antenna 110, that the label 106 may substantially shield the antenna 106 from receiving RF radiation, and thus may protect the proximity payment card 102 from unauthorized reading while it is in transit from the card issuer to the card holder. The label may be said to “entirely overlap” the antenna in the sense that the label covers essentially the entire planar extent of the antenna (although potentially not covering the leads from the antenna to the RFID chip).

If the threat of unauthorized reading is believed to be particularly severe, then it may be desirable for the mailable assembly to provide shielding on both sides of the proximity payment card antenna. A mailable assembly 100a for that purpose is shown in schematic cross-section in FIG. 5. In the mailable assembly 100a of FIG. 5, the proximity payment card 102 and the label 106 may be the same as shown in FIGS. 1-4, but the backing sheet (reference numeral 104a in FIG. 5) may be modified so as to include a conductive layer 502, at least at the locus of the label 106 and the antenna 110 (not shown in FIG. 5). The conductive layer 502 may be suitable for shielding the antenna 110 from receiving RF radiation, and may be a metal foil, for example.

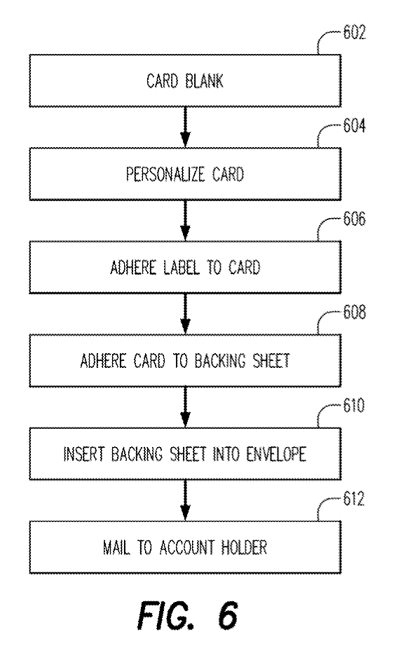

FIG. 6 is a flow chart that illustrates a process that may be performed for purposes of fulfilling an order for a proximity payment card. Except for certain features, as described hereinabove, of the proximity payment card and the label to be affixed to the card, the process of FIG. 6 may be performed in a completely conventional manner.

At 602 in FIG. 6, a proximity payment card blank is provided. Preferably the card blank has an antenna configured as described above. At 604, a procedure known as “personalization” is applied to the card blank. For the sake of concision, “personalization” should be understood to include pre-personalization. During pre-personalization, information is applied to the card that is common to all cards in the batch of cards being processed. The information may be applied by being printed and/or embossed on the card and/or loaded by RF communication into the card's RFID chip and/or magnetically stored on the card's mag stripe (if present). During personalization proper, information specific to the particular card, such as payment card account number and holder's name, is applied to the card. Again the information may be applied to the card by one or more of printing, embossing, RF communication and/or magnetic storage on the card mag stripe. The personalization step may, in accordance with conventional practices, be performed by standard automated equipment.

At 606, the protective label 106 may be adhered to the front surface of the card. This also may be done by standard equipment operating in a conventional manner. As has been stated above, it is preferable that the label be of a standard size customarily applied to payment cards, and that the label be applied to a customary standard location on the card. The label may be positioned so as to substantially shield the card antenna from RF radiation and thus protect the card from unauthorized reading.

At 608, the rear surface of the card—with the protective label in place on the front surface of the card—is adhered to the backing sheet. Again this may be done in a conventional manner. At 610 the backing sheet, with the card and the protective label, is inserted by conventional equipment into an envelope. At 612, the envelope (including backing sheet, card, label) is mailed to the intended recipient (i.e., to the prospective card holder).

There has been described hereinabove a preferred embodiment in which the proximity payment card antenna is sized and positioned so as to accommodate standard card fulfillment processing, including application of a label that is standard in size (though the label departs from the conventional by having a shielding layer incorporated therein). However, alternative embodiments are possible, and may be preferred in the event that it is desired not to reduce the size of the antenna, or not to reduce the size of the antenna as much, relative to the conventional antenna configuration. For example, if the antenna is in the conventional configuration that is substantially co-extensive with the card body, then a protective label may be used that also is substantially co-extensive with the card body. That is, the label in this embodiment may be quite a bit larger than the label conventionally applied to provide activation instructions, and may substantially cover the entire face of the card. In other embodiments, the antenna may be somewhat larger than as described in conjunction with FIG. 3, but less extensive than the conventional antenna size. In this case, the label may be larger than the standard size label described above, but need not cover the entire card surface.

It would also be possible to change the shape of the antenna (e.g., the length to width ratio) relative to antennas previously described herein, and to adapt the shape of the protective label accordingly. For example, the long dimension of the antenna may be quite a bit smaller than the antennas described above.

The principles taught herein have heretofore been described in the context of proximity payment cards. Nevertheless, these teachings are also applicable to cards or the like issued by transportation systems (e.g., mass transit systems) for access to the transportation systems; to cards used to identify the holder for purposes apart from or in addition to transaction payments; and to so-called electronic passports (also known as RFID-enabled passports). As used herein and in the appended claims the term “identification card” refers to a card-shaped object that serves as one or more of a proximity payment card, a transportation card, an identification card and/or an RFID-enabled passport. The term “transportation card” refers to a card or similar device used to pay, or confirm or evidence payment of, a charge for using a transportation system. The term “RFID-enabled passport” refers to an internationally recognized travel document that includes an IC and an antenna and communicates with a terminal by a wireless communication technique.

The present invention may also be applied to identification cards that are of a different size than the ID-1 standard size.

The above description and/or the accompanying drawings are not meant to imply a fixed order or sequence of steps for any process referred to herein; rather any process may be performed in any order that is practicable, including but not limited to simultaneous performance of steps indicated as sequential.

As used herein and in the appended claims, the term “embedded” encompasses being completely or only partially embedded.

As used herein and in the appended claims, the term “generally rectangular” includes a rectangle having rounded corners.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A mailable assembly comprising:
a backing sheet;
a proximity identification card adhered by a rear surface of the card to the backing sheet, the proximity identification card including a plastic body, a radio frequency identification (RFID) integrated circuit (IC) embedded in the plastic body, and an antenna embedded in the plastic body and coupled to the RFID IC; and
a protective label adhered to a front surface of the card, the front surface opposite the rear surface, the label including an adhesive layer by which the label is adhered to the card and at least one conductive layer for shielding the antenna from RF radiation.

2. The mailable assembly of claim 1, wherein the backing sheet includes at least one conductive layer for shielding the antenna from RF radiation.

3. The mailable assembly of claim 2, wherein the at least one conductive layer of the backing sheet includes a metal foil.

4. The mailable assembly of claim 1, wherein:
said plastic body is generally planar and card-shaped and has dimensions of substantially 85.6 mm by 53.98 mm; and
said antenna is generally rectangular and has dimensions that do not exceed about 70 mm in length and about 22 mm in width.

5. The mailable assembly of claim 4, wherein:
said plastic body has two long edges and two short edges; and
said antenna is no closer than about 7 mm to said short edges of said body.

6. The mailable assembly of claim 5, wherein said label is substantially rectangular and has dimensions of substantially 76.2 mm by 25.4 mm.

7. The mailable assembly of claim 6, wherein said label substantially entirely overlaps said antenna.

8. The mailable assembly of claim 1, wherein the at least one conductive layer includes a metal foil.

9. The mailable assembly of claim 1, wherein the proximity identification card is a payment card.

10. A proximity identification card comprising:
a generally rectangular plastic body having dimensions of substantially 85.6 mm by 53.98 mm;
a radio frequency identification (RFID) integrated circuit (IC) embedded in the plastic body; and
a generally rectangular antenna embedded in the plastic body and coupled to the RFID IC, and having dimensions that do not exceed about 70 mm in length and about 22 mm in width.

11. The proximity identification card of claim 10, wherein:
said plastic body has two long edges and two short edges; and said antenna is no closer than about 7 mm to said short edges of said body.

12. The proximity identification card of claim 11, wherein the antenna is no closer than about 3 mm to either long edge of said plastic body.

13. The proximity identification card of claim 12, wherein the dimensions of said antenna are substantially 70 mm by 22 mm.

14. The proximity identification card of claim 13, wherein said antenna is located substantially 3.5 mm from one long edge of said plastic body, and substantially 7.8 mm from each of the short edges of the plastic body.

15. The proximity identification card of claim 10, wherein the RFID IC stores a payment card account number.

16. A method comprising:
adhering a proximity identification card to a backing sheet, the proximity identification card including a plastic body, a radio frequency identification (RFID) integrated circuit (IC) embedded in the plastic body, and an antenna embedded in the plastic body and coupled to the RFID IC; and
adhering a protective label to the proximity payment card, the label including an adhesive layer by which the label is adhered to the card and at least one conductive layer for shielding the antenna from RF radiation.

17. The method of claim 16, further comprising:
inserting the backing sheet with the card and the label into an envelope.

18. The method of claim 17, further comprising:
mailing the envelope with the backing sheet, the card and the label to an individual who is appointed to receive the card.

19. The method of claim 16, further comprising:
storing a payment card account number in the RFID IC.

20. The method of claim 16, wherein the label is adhered to the card before the card is adhered to the backing sheet.
